(19) United States
(12) Patent Application Publication
(10) Pub. No.: US 2010/0306913 A1
(43) Pub. Date: Dec. 9, 2010

(54) LEAKPROOF DISPOSABLE BEDPAN WITH INTEGRAL BIOHAZARD CONTAINMENT

(76) Inventors: Susan Zazzara, Fort Lauderdale, FL (US); Brian Zazzara, Fort Lauderdale, FL (US)

Correspondence Address: JOHN C. SMITH, P.A., 4125 NW 58th LANE, BOCA RATON, FL, 33496, US

(21) Appl. No.: 12/480,605

(22) Filed: Jun. 8, 2009

(51) Int. Cl. A61G 9/00

(52) U.S. Cl. 4/451

(57) ABSTRACT

A disposable biodegradable bedpan having antimicrobial agents that can be applied to the interior surfaces or infused into the bedpan during the molding process. The antimicrobial agents act to neutralize the biohazardous material within the human waste. The bedpan is designed with sloping walls such that it can be nested to facilitate storage. In addition, the bedpan can optionally contain an internal gelling agent to solidify liquid waste to avoid accidental spillage. Optional indicia are also provided on the inner wall of the bedpan to allow estimation of the volume of the contents. The bedpan has an optional lid that can be sealed after use to avoid spillage. The bedpan can be fabricated with molded paper pulp, or by an alternative biodegradable material such as PLA.

### BACKGROUND

### Technical Field

This invention relates in general to medical equipment, and more particularly it relates to a disposable bedpan designed to safely contain human waste without spillage of viral and bacterial contaminants by utilizing a gelling agent to prevent fluid leakage, and by utilizing an integral antimicrobial agent to destroy biohazardous organisms contained in human waste.

### BACKGROUND OF THE INVENTION

Over time, a variety of new and deadly diseases have developed. Some of these diseases developed as the result of normal evolutionary processes. Others have developed mutations brought about as a result of exposure to a variety of antiviral and antibacterial medications that have resulted in the development of infectious agents that are either highly or completely resistant to known treatments.

For example, one such disease is brought about by MRSA (Methicillin Resistant Staphylococcus Aureus). MRSA is a bacterium that can cause infections throughout the body. It is highly resistant to many commonly used antibiotics, and is therefore more difficult to treat than most strains of staphylococcus aureus (e.g. staph). Regrettably, MRSA is only one example of many dangerous infectious agents that now represent a significant health risk to the public.

Another, even more dangerous disease is Clostridium Difficile (“C.diff”). C.diff is a species of bacteria of the genus Clostridium. Clostridia are anaerobic, spore-forming rods (bacillus). It is the most serious cause of antibiotic-associated diarrhea and can lead to other problems such as pseudomembranous colitis, which is a severe infection of the colon that results from eradication of the normal gut flora by antibiotics. When this happens, the C.diff bacteria, which naturally reside in the body, become overgrown. The overgrowth results in the release of bacterium toxins that can cause bloating, constipation, and diarrhea with abdominal pain, which may become severe.

C.diff, like MRSA, is highly infectious and in some situations, such as hospitals or nursing homes, the likelihood of passing infections from one person to another is high.

Unfortunately, these represent only two significant health problems that confront the health industry on a daily basis. Other infectious agents include, but are not limited to, bacteria such as E. coli, Pseudomonas Aeruginosa, Staphylococcus Typhimurium, Salmonella, Mycobacterium Tuberculosis, Yersinia Enterocolitica, and Camplyobacter Jejuni. In addition to bacterial infections, there are also a variety of viral infections, including Polioviruses, Adenoviruses, Rotaviruses, Hepatitis Viruses, Influenza viruses and HIV. As can be seen, there is no shortage of dangerous infectious agents which individuals are exposed to in environments such as hospitals and nursing homes.

In light of the above, such facilities are a breeding ground for infection due to the close proximity of hospital patients and nursing home residents to one another. Another factor is the interaction of service personnel with many patients or nursing home residents over the course of each day that results in direct contact between individuals that may spread infection. Those skilled in the art will recognize that while a hospital environment is used as a convenient way of discussing the problem, the same problems can arise in any facility in which people are cared for, such as nursing homes, hospices, endoscopy centers, home health care, etc.

In addition to direct physical contact with an infected individual, a significant risk of spreading infection is also created by contact with human waste produced by patients. Many patients are unfortunately bedridden due to chronic illness or temporary conditions that require hospitalization. As a result, bedpans are required to help them relieve themselves when they cannot get out of bed. In facilities such as hospitals, nursing homes, etc, this can create health hazards due to the potential spread of materials that are contaminated with infectious agents, allowing for the transmission of the organisms to “clean” areas and to non-infected patients. This can occur from direct patient care resulting in cross-contamination of the medical personnel's clothing or the under surface of their shoes.

Not only are those in direct contact with patients at risk, but workers handling biohazardous material downstream from the patients are also at risk. It would be desirable to have a method of containing and neutralizing the contaminated materials at the point of service (“POS”) so that anyone having to handle them would be protected.

A variety of protocols have been developed for handling hazardous material. However, prior art methods often leave individuals exposed to infection. This is particularly true for bedpans. In a hospital environment, medical personnel will have to carry a bedpan to a service area for disposal and/or cleaning. In the event the bedpan is mishandled, the contents can be spilled, thereby contaminating a large area. It would be desirable to have a method of protecting against inadvertent spillage of contaminated or hazardous material.

Another problem with prior art bedpans is that they are typically reusable plastic devices that have to be cleaned after each use. Of course, the emptying and cleaning process represents one more possible exposure to contamination. It would be desirable to have a method of avoiding exposure to biohazardous material after the bedpan has been used. In addition to avoiding contamination, it would also be desirable to have a method of handling waste in a “green” manner which would avoid generating non-biodegradable refuse such as the plastic bedpans which are currently used.

Another problem associated with human waste when transported in bedpans is that depending on the fluidity of the waste, the chance of spillage increases. It would be advantageous to have a method of preventing liquid waste from easily spilling from the bedpan.

Yet another problem associated with a prior art bedpan is that any biohazardous agents contained therein will remain active and dangerous during transport. It would be desirable to have a method of neutralizing any biohazard danger while the waste remains in the bedpan.

In addition to the foregoing problems, it is often necessary for medical personnel to know the volume of the contents of a bedpan prior to disposal. It would be advantageous to have a method for estimating the contents of a bedpan while minimizing contact with the waste material.

While the prior art has provided a basic bedpan for use by patients, it has failed to provide a bedpan that is specifically designed to reduce the possibility of contamination from human waste by preventing accidental spillage, and/or exposure to the environment. Further, the prior art has not provided a convenient method of reducing waste fluidity during transport, and reducing the biohazard risk level while waste remains in the bedpan.

### SUMMARY OF THE INVENTION

This invention provides a disposable molded pulp bedpan designed to avoid spillage and cross-contamination. The bedpan optionally has antimicrobial agents that can be applied to the interior surfaces or infused into the bedpan during the molding process. The antimicrobial agents act to neutralize the biohazardous material within the human waste. In addition, the bedpan can optionally contain an internal gelling agent to solidify liquid waste to avoid accidental spillage. Optionally, indicia may be provided on the inner wall of the bedpan to allow estimation of the volume of the contents. The bedpan is structured such that it can be nested to facilitate storage.

### BRIEF DESCRIPTION OF THE DRAWINGS

FIG. 1 is a top view of a preferred embodiment of the disposable bedpan.

FIG. 2A is a side view of a preferred embodiment of the disposable bedpan.

FIG. 2B is a cross-sectional view of a preferred embodiment of the disposable bedpan that illustrates the structural support given to the patient by the progressive widening of the wall.

FIG. 3 is a front view of a preferred embodiment of the disposable bedpan.

FIG. 4 is side view of a preferred embodiment of a plurality of disposable bedpans nested one within another for storage.

FIG. 5A is a top view of a preferred embodiment of the disposable bedpan with an internal absorbent material secured to the inside of the disposable bedpan.

FIG. 5B is a transparent side view of a preferred embodiment of the disposable bedpan illustrating the absorbent material secured by adhesive material to the inside of the disposable bedpan.

FIG. 6A is a top view of a used disposable bedpan with the lid sealed to the body of the bedpan.

FIG. 6B is a side view of a used disposable bedpan with the lid sealed to the body of the bedpan.

FIG. 7 is a side view of an alternative preferred embodiment having internal indicia to indicate the amount of material in the disposable bedpan.

### DETAILED DESCRIPTION OF THE PREFERRED EMBODIMENT

Prior to a discussion of the figures, an overview of the invention will be presented. The invention is a disposable molded bedpan. Once the bedpan is used, it can be transported for disposal with a minimum risk of spillage.

Another important feature of the invention is the use of antimicrobial agents to neutralize biohazardous microbial material that may be in human waste. In a preferred embodiment, a commercially available antimicrobial agent (Teflex (TM)) is used. Teflex is a polymeric disinfectant made from compounds of guanidine copolymers that are modified with additional functional groups. An advantage of Teflex is that it is harmless to humans and animals, non-corrosive, non-toxic, odorless, colorless, and long lasting in effect and protection. In addition, polymeric disinfectants demonstrate very high biocidal activity, killing viruses, bacteria, mold and mildew. Teflex is non-carcinogenic and does not provoke allergic reactions. It has long-lasting antimicrobial properties and does not cause antimicrobial resistance.

An advantage of Teflex is that it has an extremely long shelf life, measuring in years. As a result, it is particularly useful in a commercial environment where large quantities of bedpans may be inventoried.

While Teflex has been found to be a suitable antimicrobial agent for the purposes of the invention, those skilled in the art will recognize that any suitable antimicrobial agent can be used. For example, a colloidal silver treatment can also be used as an antimicrobial agent. Therefore, while Teflex is used throughout the specification to explain the principles of the invention, it should be understood that any suitable antimicrobial agent could be used.

In the preferred embodiment, the Teflex is applied to the inner surface of the bedpan. Alternatively, the Teflex, or other suitable agent, can be incorporated into the wall of the bedpan during the molding process.

Another feature of this invention is the optional use of a gelling agent to solidify liquid waste in a used bedpan. One of the problems associated with prior art bedpans is that they typically are open devices. As a result, accidental spillage can often result when transporting used bedpans. By incorporating a gelling agent within the bedpan, liquid waste is converted into a gel or solid which is less likely to be spilled. Any suitable commercial gelling agent can be used for this purpose. In the preferred embodiment, the gelling agent is secured to the inside of the pan. This can be done by placing the gelling agent within a porous sack, which is secured to the bedpan via double stick tape or adhesive. Alternatively, the gelling agent can be applied to a contact paper that is secured to the inner surface of the bedpan.

A preferred embodiment of the invention uses a commercially available absorbent polymer (i.e. Sodium Polyacrylate). Sodium Polyacrylate is also named acrylic sodium salt polymer. It has an ability to absorb hundreds of times its mass in water, and has a formula of [—CH₂—CH(COONa)—] repeating. Due to the extraordinary absorptive power of Sodium Polyacrylate, a substantial amount of liquid waste can be contained in the bedpan without spillage. In addition, the Sodium Polyacrylate can be formed into flat strips that are directly applied to the internal cavity of the bedpan. As a result, it would not require any containment device such as the porous sack discussed above.

Another feature of the invention is an optional lid. In a preferred embodiment, the lid has an adhesive strip that secures to the peripheral upper surface of the bedpan. Once installed, the bedpan completely encloses the human waste thereby avoiding spillage. Those skilled in the art will recognize that the lid can be attached in any suitable manner.

Another feature of this invention is the use of optional internal indicia on the inside wall of the bedpan. This allows medical personnel to estimate the amount of waste in a bedpan without having to come in contact with it, or having to pour it into a separate measuring container. The indicia can be printed on the inner wall of the bedpan, applied as a sticker, or preferably, molded into the wall of the bedpan during manufacture.

The preferred embodiment uses paper pulp that is molded to form the molded bedpan. Molded pulp provides several advantages. First, it is biodegradable. As a result, there is a minimal impact on the environment. Another advantage is the low cost of producing the molded bedpan from pulp. This reduces cost for the facility providing care, and should reduce cost to the patients. The disposable nature of the molded bedpan also means that handling is reduced, since the molded bedpan does not require cleaning for reuse. As a result, labor costs are further reduced.

An alternative embodiment envisions that the bedpan could also be fabricated from material other than molded pulp. In particular, the molded bedpan can also be fabricated from material such as PLA Resin (Polylactic Acid). PLA resin was originally developed to replace PET plastic in the manufacturing of Water Bottles. It provided an eco-friendly alternative to petroleum-based plastic, and is now used in a variety of applications.

PLA is a biodegradable plastic that is made from corn. Products produced with PLA are compostable within 45-120 days. The main component of PLA is Polylactide, which is a versatile polymer made from lactic acid. Lactic Acid is made from dextrose by fermentation. Dextrose is made from cornstarch. In turn, cornstarch is made from carbon dioxide and water. Thus, when a PLA product composts, it simply biodegrades into carbon dioxide and water. The result is a product that does not require any petroleum for manufacture, and does not create any permanent environmental problems.

As an alternative to composting, PLA plastic can be incinerated and burns clean. Because it is clean burning, it can be used as a bio-fuel and incinerated as a compact source of corn-based (i.e., Ethanol) bio-fuel. As a result, PLA provides the advantage of turning plastic containers into a power source.

PLA provides an additional advantage in that it possesses superior rigidity, high heat resistance, low taste transfer, high gloss, and oil resistance. This allows PLA to be a possible replacement for Polystyrene, ABS and/or PET plastics. Common applications include cups, disposable goods, packaging, food containers, automotive interiors, bags, bottles, and food service products.

PLA provides a further advantage in that it is relatively inexpensive to manufacture. Also, PLA provides a trade advantage in that it is made from domestically grown corn.

In the preferred embodiment, each molded bedpan is a stand-alone unit. Alternatively, each molded bedpan can be a disposable insert that can be inserted into a permanent outer bedpan structure. The advantage of this approach is that the molded bedpan would not have to have enough structural strength to support the weight of the patient. Patient support would be provided by the outer bedpan structure. This would allow a less costly molded insert, but one that would have the same advantages as the stand-alone molded bedpan discussed above.

Another advantageous feature of the invention is the use of biodegradable materials to fabricate the body of the molded pulp bedpan. The use of biodegradable materials is intended to create the minimum long-term impact on the environment when disposing of a used bedpan.

Having discussed the invention in general, we turn now to a detailed discussion of the drawings.

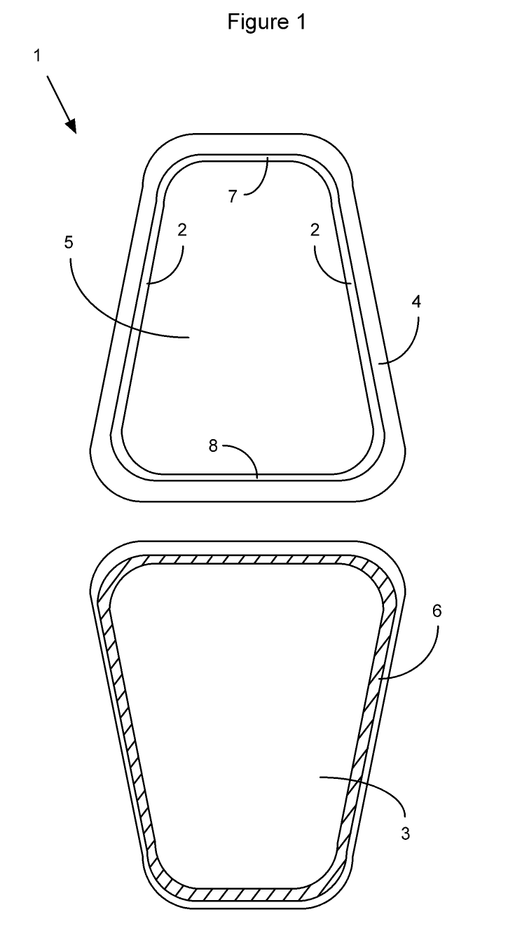

FIG. 1 is a top view of a preferred embodiment of the disposable bedpan 1. In this view, the bottom surface 5 of the disposable bedpan 1 is shown. Also shown are side walls 2, front wall 7, and rear wall 8 which define the cavity of the disposable bedpan 1. Also shown is upper surface 4 that extends around the periphery of disposable bedpan 1. Sealing tape 6 extends around the periphery of optional upper lid 3. In the preferred embodiment, a paper strip is secured to sealing tape 6 to protect the adhesive therein until use. When the disposable bedpan 1 is to be sealed, the paper strip is removed to expose the sealing tape 6. Then the upper lid 3 is moved into position such that upper lid 3 makes contact with upper surface 4. At this point, the contents of the disposable bedpan 1 are sealed within.

For ease of illustration, the wall structure of the disposable bedpan 1 is shown having a generally trapezoidal shape formed by front wall 7, rear wall 8, and side walls 2. However, those skilled in the art will recognize that the shape of the bedpan 1 can vary any number of ways so long as it is functional for its intended purpose. It can, for example, be circular in shape, etc. The only requirement is that the walls, regardless of how many there are, form a peripheral wall that connects the bottom surface 5 of the disposable bedpan 1 to the upper surface 4.

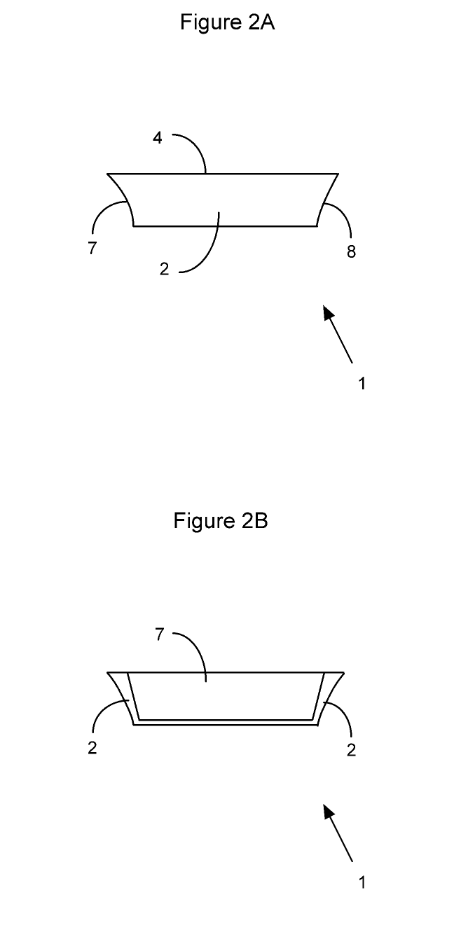

FIG. 2A is a side view of a preferred embodiment of the disposable bedpan 1. In the preferred embodiment, the side walls 2, the front wall 7 and rear wall 8 are designed with sloped surfaces to allow nesting one disposable bedpan 1 into another. In addition, the walls 2, 7 and 8 are designed to be progressively thicker as they near the top surface 4 to provide sufficient strength to support a patient's weight.

FIG. 2B is a cross-sectional view of the disposable bedpan 1. In this view, the side walls 2 are shown to progressively widen to provide structural support for the patient during use. Due to the enhanced thickness of the side walls 2, front wall 7, and rear wall 8 (shown in FIG. 2A, the disposable molded bedpan 1 can be used as a stand-alone unit without the need for a patient support structure.

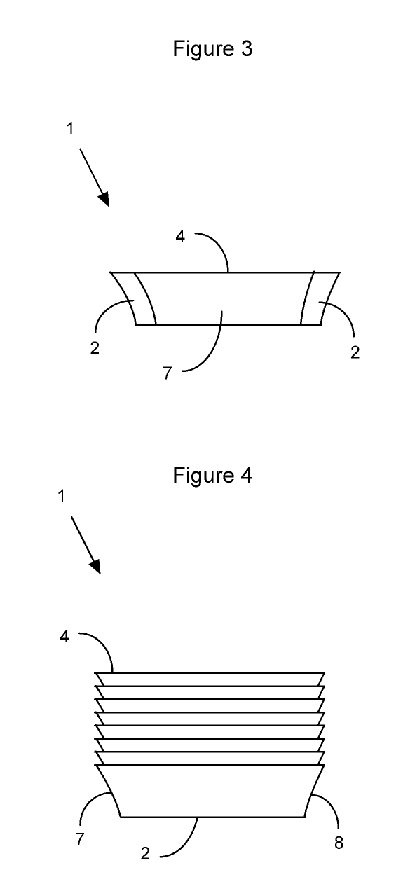

FIG. 3 is a front view of a preferred embodiment of the disposable bedpan 1. This figure illustrates the sloped side walls 2. As was the case with front wall 7 and rear wall 8, the sloped surfaces are designed to allow nesting one disposable bedpan 1 within another. This provides a significant storage advantage to large organizations that may stock thousands of these devices.

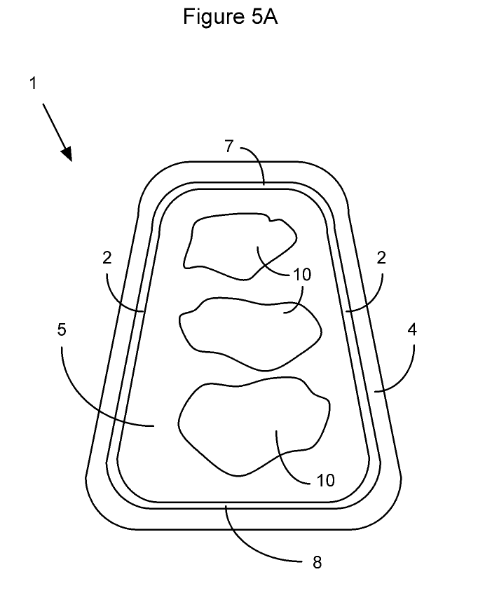

FIG. 4 is a side view of a preferred embodiment of a plurality of disposable bedpans 1 nested one within another for storage. As can be seen in this figure, the nesting capability greatly reduces the space required for storage.

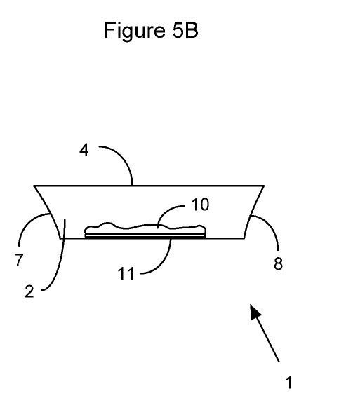

FIG. 5A is a top view of a preferred embodiment of the disposable bedpan 1 with an internal absorbent material 10 secured to the inside of the disposable bedpan 1. For illustrative purposes, the absorbent material 10 is shown having irregular shapes. However, any suitable shape can be selected. The advantage of using absorbent material 10 is that it further reduces the possibility of spillage. As discussed above, Sodium Polyacrylate can be used as the absorbent material 10. However, those skilled in the art will recognize that any other suitable absorbent material 10 can be used.

FIG. 5B is a transparent side view of a preferred embodiment of the disposable bedpan 1 illustrating the absorbent material 10 secured by adhesive material 11 to the inside of the disposable bedpan 1. In this figure, the absorbent material 10 can be loose granular material confined to a porous sack that is secured by adhesives or an adhesive strip 11. Alternatively, it can be formed as a flat strip that is directly adhered to a surface of the disposable bedpan 1.

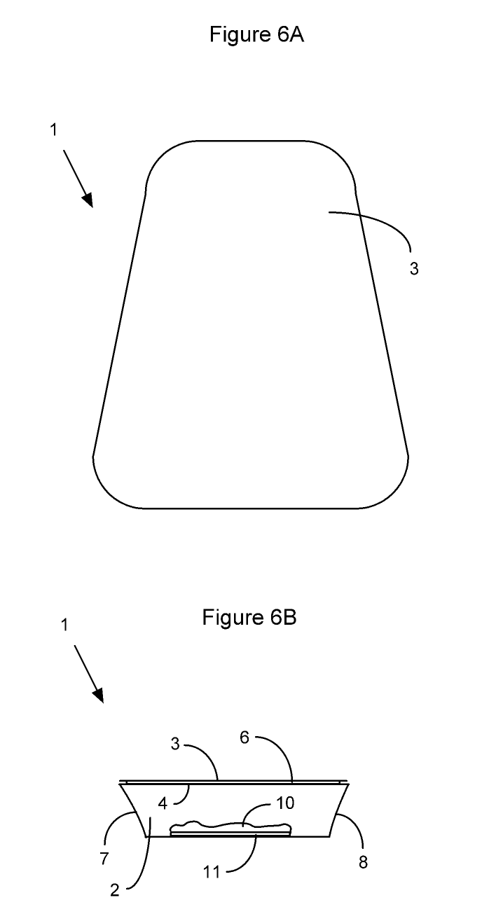

FIG. 6A is a top view of a used disposable bedpan 1 with the upper lid 3 sealed to the body of the disposable bedpan 1. As can be seen, once upper lid 3 is sealed, the contents of disposable bedpan 1 are prevented from leaking out.

FIG. 6B is a side view of a used disposable bedpan 1 with the upper lid 3 sealed to the body of the disposable bedpan 1. This figure further illustrates the fact that, once sealed, the upper lid 3 securely contains the contents of the disposable bedpan 1.

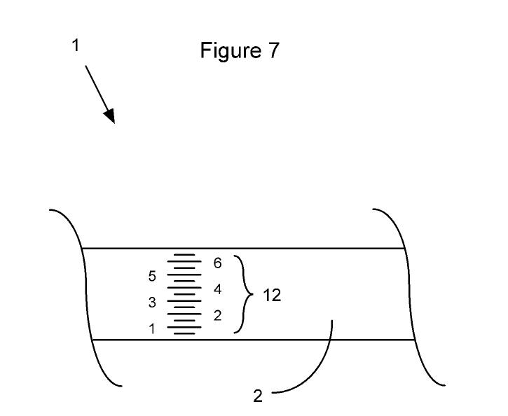

FIG. 7 is a side view of an alternative preferred embodiment having internal indicia 12 to indicate the amount of waste material in the disposable bedpan 1. Typically, the volumetric measurements are labeled in cubic centimeters or milliliters, and are typically in 25 or 50 cc or ml increments.

While specific embodiments have been discussed to illustrate the invention, it will be understood by those skilled in the art that variations in the embodiments can be made without departing from the spirit of the invention. For example, the size and shape of the disposable bedpan can vary, the adhesive material used to seal the lid can vary, the material used to fabricate the bedpan can vary, etc. Therefore, the invention shall be limited solely to the scope of the claims. We Claim:

1. A disposable molded bedpan, comprising:
a bottom surface;
at least one peripheral wall extending around the periphery of the bottom surface, the peripheral wall having sufficient thickness to support patient body weight during use;
an upper surface extending around the periphery of the peripheral wall, and supported by the peripheral wall, the upper surface substantially parallel with the bottom surface;
the disposable molded bedpan fabricated from pulp or PLA; and
whereby, the disposable bedpan is usable without any external support structure and can be discarded after use.

2. A bedpan, as in claim 1, wherein:
the inner surface of the bedpan is treated with antimicrobial agents;
whereby biohazardous material in human waste that is deposited in the bedpan is neutralized by the antimicrobial agents.

3. A bedpan, as in claim 2, wherein:
the antimicrobial material further comprises guanidine copolymers.

4. A bedpan, as in claim 3, further comprising:
a gelling agent disposed in the bedpan to gel liquid waste deposited in the bedpan;
whereby inadvertent spillage of liquid waste is avoided by capturing the liquid with the gelling agent.

5. A bedpan, as in claim 3, wherein:
the material used to fabricate the bedpan is biodegradable.

6. A bedpan, as in claim 2, further comprising:
a gelling agent disposed in the bedpan to gel liquid waste deposited in the bedpan;
whereby inadvertent spillage of liquid waste is avoided by capturing the liquid with the gelling agent.

7. A bedpan, as in claim 1, wherein:
antimicrobial agents are included in the material used to fabricate the bedpan;
whereby biohazardous materials in human waste that is deposited in the bedpan are neutralized by the antimicrobial agents.

8. A bedpan, as in claim 7, further comprising:
the antimicrobial material further comprises guanidine copolymers.

9. A bedpan, as in claim 8, further comprising:
a gelling agent disposed in the bedpan to gel liquid waste deposited in the bedpan;
whereby inadvertent spillage of liquid waste is avoided by capturing the liquid with the gelling agent.

10. A bedpan, as in claim 8, wherein:
the material used to fabricate the bedpan is biodegradable.

11. A bedpan, as in claim 7, further comprising:
a gelling agent disposed in the bedpan to gel liquid waste deposited in the bedpan;
whereby inadvertent spillage of liquid waste is avoided by capturing the liquid with the gelling agent.

12. A bedpan, as in claim 1, wherein:
the material used to fabricate the bedpan is biodegradable.

13. A bedpan, as in claim 12, further comprising:
the thickness of the peripheral wall widens as it approaches the upper surface.

14. A bedpan, as in claim 13, wherein:
the peripheral wall is sloped to allow multiple bedpans to be nested one within another.

15. A bedpan, as in claim 14, wherein:
the bedpan further comprises the antimicrobial material guanidine copolymers; and
a gelling agent is disposed in the bedpan to gel liquid waste deposited in the bedpan;
whereby inadvertent spillage of liquid waste is avoided by capturing the liquid with the gelling agent.

16. A bedpan, as in claim 15, wherein:
the interior of the bedpan further comprises indicia;
whereby the approximate amount of the contents of the bedpan can be measured using the indicia.

17. A bedpan, as in claim 1, further comprising:
a lid, sized to cover the upper surface of the bedpan; and
means to seal the lid to the upper surface of the bedpan such that the contents of the bedpan are secured within it.

18. A bedpan, as in claim 1, wherein:
the peripheral wall is sloped to allow multiple bedpans to be nested one within another.

19. A biodegradable disposable molded insert for a bedpan, comprising:
a bottom surface;
at least one peripheral wall extending around the periphery of the bottom surface;
an upper surface extending around the periphery of the peripheral wall, and supported by the peripheral wall, the upper surface substantially parallel with the bottom surface;
the disposable molded insert is fabricated from biodegradable pulp and/or PLA; and
the biodegradable pulp and/or PLA further comprises the antimicrobial material guanidine copolymers;
whereby, the disposable molded insert for the bedpan can be discarded after use.

20. A molded insert, as in claim 19, further comprising:
a gelling agent disposed in the molded insert to gel liquid waste deposited in the bedpan; and
the material used to fabricate the bedpan is biodegradable.
